(19) United States
(12) Patent Application Publication
(10) Pub. No.: US 2012/0285941 A1
(43) Pub. Date: Nov. 15, 2012

(54) BAND FOR PROTECTING ELECTRODES OF A SPOT-WELDING GUN

(75) Inventor: Mario LOIPETSBERGER, Oberndorf (AT)

(73) Assignee: FRONIUS INTERNATIONAL GMBH, Pettenbach (AT)

(21) Appl. No.: 13/557,429

(22) Filed: Jul. 25, 2012

Related U.S. Application Data
(62) Division of application No. 12/087,764, filed on Jul. 14, 2008.

(30) Foreign Application Priority Data
Feb. 8, 2006 (AT) A 193/2006

(51) Int. Cl. B23K 9/28

(52) U.S. Cl. 219/138

(57) ABSTRACT

A band for protecting electrodes of a spot-welding gun for welding metal sheets includes a carrier material. At least one electrically conductive layer is provided on the side facing the metal sheets. At least two layers are provided on the metal-sheet side of the carrier material in order to create such a band when welding aluminum and/or aluminum alloys, via which the contrast of the imprint of the welding spot can be increased and the electrode can be protected optimally. The outermost layer is made of tin and the layer arranged therebelow is made of nickel-phosphorous. Furthermore, on the carrier material, at least one adhesive layer may be provided for the layers superimposed.

### CROSS REFERENCE TO RELATED APPLICATIONS

This application is a divisional of and Applicant claims priority under 35 U.S.C. §120 and 121 of U.S. application Ser. No. 12/087,764 filed on Jul. 14, 2008, which application is a national stage application under 35 U.S.C. §371 of PCT Application No. PCT/AT2007/000019 filed on Jan. 18, 2007, which claims priority under 35 U.S.C. §119 from Austrian Patent Application No. A 193/2006 filed on Feb. 8, 2006, the disclosures of each of which are hereby incorporated by reference. A certified copy of priority Austrian Patent Application No. A 193/2006 is contained in parent U.S. application Ser. No. 12/087,764. The International Application under PCT article 21(2) was not published in English.

### BACKGROUND OF THE INVENTION

1. Field of the Invention

The invention relates to a band for protecting the electrodes of a spot-welding gun or a spot-welding device for welding metal sheets made of aluminum and/or an aluminum alloy.

Likewise, the invention relates to a band for protecting the electrodes of a spot-welding gun for welding metal sheets made of steel and/or steel alloys.

2. The Prior Art

WO 2004/022278 A1 describes a method for monitoring the quality of spot-weldings, in particular for robot applications. At least two electrodes are pressed against each other and charged with energy, the metal sheets to be welded with each other being interposed. Here, the welding spot is evaluated by an evaluation means, in particular an optical image-detecting means. A band is inserted between the electrodes and/or the electrode caps and the metal sheets, said band protecting the electrodes from wearing. The band is configured such that a mirror-inverted imprint of the welding spot created on the metal sheet is formed on the band. This imprint is detected and evaluated by the evaluation means. The imprint allows for conclusions as to the size, shape and position of the welding spot and, thus, to the quality of the welding. Preferably, when welding aluminum metal sheets, a tinplate band and/or a band with a tin coating is used, and when welding galvanized metal sheets, a copper band and/or a band with a copper coating is used.

Here, it is disadvantageous that since the tin layer is provided directly on the material of the band, a conclusive evaluation of the mirror-inverted welding spot is reasonable only several hours after the spot welding. Only after several hours the contrast will be obtained necessary for optical detection by the evaluation means.

From U.S. Pat. No. 5,552,573 A, there is known an electrode-protective band for a resistance-welding process for aluminum or aluminum alloys, wherein the band consists of a base material which is coated with the same or a different material on either side. The base material consists of iron, steel, copper or a copper alloy and has a thickness of from 0.02 mm to 1 mm. The layers applied may consist of nickel, titanium, niobium, molybdenum, tungsten, chromium, cobalt, or alloys thereof, and have a thickness of in the range of from 1 to 100 μm.

Here, it is disadvantageous that since the individual layers are of a small thickness, they do not lead to a contrast on the base material which is sufficient for detecting and picturing the mirror-inverted imprint of the welding spot. The layers known only serve the purpose of substantially increasing the service life of the electrodes. Also the coatings known allow for a protection of the electrodes only when aluminum or aluminum alloys are welded.

Different bands for protecting the electrodes of a spot-welding gun for welding metal sheets made of different materials are also known from WO 2004/004961 A2, WO 2004/078404 A1 and JP 5 318 136 A.

### SUMMARY OF THE INVENTION

The object of the present invention resides in creating the above-mentioned bands for protecting the electrodes of a spot-welding gun, on which gun the imprint of the welding spot is clearly defined, i.e. a high contrast is formed as soon as possible after the spot welding.

A further object of the invention resides in substantially increasing the service life of the electrode during spot welding of metal sheets made of steel and/or steel alloys and aluminum and/or aluminum alloys by using a corresponding band.

The object is achieved by a band according to the invention, wherein at least two layers are provided on the metal-sheet side of the carrier material, wherein the outermost layer and the layer arranged therebelow are made of nickel phosphorous. Here, it is advantageous that additionally to an increased service life of the electrode due to the use of the band with appropriate layers, the mirror-inverted imprint of the welding spot formed on the band during the spot-welding process substantially differs from the surrounding surface of the band. That is, the layers form an annular ring around the welding spot and, thus, define the welding spot relative to the surface of the metal sheets to be welded, i.e. form a high contrast. Thus, the visual evaluation means, e.g. a camera, can detect and measure the welding spot substantially directly after the spot-welding process. This substantially facilitates monitoring the quality of the individual welding spots, since the detection and evaluation of the welding spot is effected substantially simultaneously with the spot-welding and, thus, the welding spot documented by the evaluation means can be assigned to the true welding spot in a simple fashion. Thus, a contrast formation is ensured which is faster compared to that provided by the prior art. The above-mentioned composition of the electrode-protective band is particularly suited when welding metal sheets made of aluminum or an aluminum alloy.

If the nickel-phosphorous layer has a thickness of from 0.1 μm to 0.5 μm, the carrier material of the band is prevented from diffusing with the material of the electrode on the electrode side, which, with an increasing number of spot-welding processes, leads to a layer on the contact surface of the electrodes, resulting in a substantial increase of the contact resistance from the electrode to the band. Accordingly, these two layers on the metal-sheet side do not cause any deterioration of the current transfer, thus not negatively influencing the spot-welding process, irrespective of the number of spot-weldings done. Likewise, the phosphorous portion has the effect that the annular ring around the mirror-inverted imprint of the welding spot on the carrier material is darkened on the metal-sheet side. This occurs substantially after the spot-welding process such that there is a high contrast and such that the evaluation means can detect and evaluate the imprint immediately after the spot-welding process.

Preferably, the tin layer has a thickness of from 0.2 to 1.5 μm. Thus, the contact transfer and/or the current transfer to the metal sheets to be welded is improved. This is mainly achieved in that the oxide layer on the surface of the metal sheet is torn open at some regions due to the electrode pressure prevailing during the spot-welding process, the soft tin subsequently embedding in these regions. This also improves the contact transfer and, additionally, favors a spatter-free welding process. A further substantial advantage results from the low melting point of the tin layer. This influences the spot-welding process positively in a manner that only a very small amount of the molten tin penetrates into metal sheet and that excessive tin is displaced from the welding spot by the electrode pressure. On the one hand, this results in that the properties of the metal sheets welded are not changed, since the tin has been displaced before it could penetrate into metal sheet. On the other hand, this results in that the displaced tin forms a uniform surface-covering annular ring around the welding spot, thus additionally enhancing the contrast of the mirror-inverted imprint of the welding spot on the band formed by the nickel-phosphorous layer. Thus, the welding spot on the band can be detected and evaluated by the evaluation means in a quick and exact manner.

According to a further feature of the invention, at least one adhesive layer for the layer superimposed is provided on the carrier material.

Advantageously, the adhesive layer made of nickel or a nickel-alloy has a thickness of from 0.1 to 0.5 μm. This facilitates the application of the layers essential for contrast formation and/or contrast-enhancing layers, since the adhesive layer serves as an adhesive promoter for these layers.

Likewise, the object is achieved by a band according to another aspect of the invention, wherein at least the copper layer provided on the metal-sheet side of the carrier material has a thickness of in the region of 200 nm. Here, it is advantageous that the extremely thin copper layer provides for a well-visible contrast to the metal sheets made of aluminum. This results from the fact that the aluminum of the metal sheets diffuses into the copper of the copper layer on the metal-sheet side of the carrier material, allowing for the mirror-inverted imprint of the welding spot to be clearly detected by the evaluation means. This advantage can be made use of only because of the extremely thin copper layer, since if the copper layer was thicker, the aluminum of the metal sheets would diffuse far into the copper of the copper layer on the metal-sheet side of the carrier material, which would result in a carrier material and/or band sticking to the metal sheet, leading to a stop of the spot-welding process. This kind of electrode-protective band is particularly suited when welding metal sheets made of an aluminum alloy, in particular an AlMgSi alloy.

Likewise, a layer made of copper may be provided on the side of the carrier material facing the electrode, said layer having a thickness of in the range of 200 μm.

An object is also achieved by a band according to a further aspect of the invention, wherein the nickel layer is arranged on an adhesive layer made of nickel and provided on the carrier material, said nickel layer having a thickness of from 0.1 μm to 0.5 μm. This electrode-protective band is particularly suited when welding metal sheets made of aluminum or an aluminum alloy. By combining the adhesive layer provided on the carrier material with the nickel layer, it is achieved that higher currents can be used for the spot-welding process, wherein the thus increased danger that the carrier material and/or the metal sheet stick to the band is correspondingly strongly reduced or eliminated by the layers.

Advantageously, the adhesive layer made of nickel has a thickness of in the range of about 200 nm.

The object is also achieved by a band according to a further aspect of the invention, wherein the copper layers have a thickness of from 0.1 μm to 0.6 μm. Here, it is advantageous that the carrier material is prevented from diffusing into the contact surface of the electrode since the layer made of copper has a corresponding thickness, thus increasing the service life of the electrode. Furthermore, by the corresponding thickness of the layer made of copper it is also advantageously achieved that the copper layer improves the contact transfer from the electrode to the band. Likewise, it is also advantageous that the layer made of copper provides for a corrosion protection of the carrier material and/or the band. By the copper layer on the metal-sheet side of the carrier material, the contact transfer between the band and the metal sheets to be welded is improved. Furthermore, by identical layers made of copper on the metal-sheet side and the electrode side, a quick and cheap production of the band is provided for. Likewise, it is advantageous that the layer made of copper provides for a corrosion protection of the carrier material and/or the band.

Likewise, an object is achieved by an electrode-protective band according to a further aspect of the invention, wherein at least two layers made of different materials are provided on the side of the carrier material facing the electrode, wherein one layer is made of copper and one layer is made of nickel and/or a nickel alloy, and wherein each layer has a thickness of from 0.5 μm to 1.5 μm. Here, it is advantageous that the carrier material is prevented from diffusing into the contact surface of the electrode thanks to the corresponding thickness of the layers, thus increasing the service life of the electrode. Furthermore, by the corresponding thickness of the layers it is advantageously achieved that the contact transfer from the electrode to the band is improved. Likewise, it is also advantageous that the layers provide for a corrosion protection of the carrier material and/or the band. By combining the layers, it is advantageously achieved that a substantially higher current can be transferred from the electrode to the band without any negative effects on the service life of the electrode.

If the copper layer is arranged on an adhesive layer with a thickness of in the range of 200 nm, said adhesive layer being provided on the carrier material and being made of copper, the application of the layers superimposed for achieving higher welding currents is facilitated since the adhesive layer serves as an adhesive promoter.

According to a further feature of the invention, it is provided that the carrier material is made of copper and has a thickness of from 0.1 to 0.3 mm. Thus, it is advantageously achieved that the required stability of the band is ensured and that high currents can be used for welding processes due to the excellent electric conductivity.

If the layers arranged on the metal-sheet side of the carrier material are identical to the layers provided on the electrode side of the carrier material, production will be facilitated since no complex works will be necessary for covering one side of the carrier material. Likewise, it is of advantage that the layers arranged on the carrier material on either side meet the respective requirements. The layers protect the electrode on the electrode side and improve contrast formation on the metal-sheet side. The protection of the electrode is strengthened by the lacking layer made of tin on the electrode side, since this layer would cause depositions on the electrode. Thus, the service life of the electrode is substantially increased.

If the carrier material is made of soft steel and has a thickness of from 0.1 to 0.2 mm, the required stability of the band is ensured. Likewise, the individual layers on the carrier material, i.e. steel, on either side substantially increase corrosion resistance of the steel. A further advantage resides in that due to the soft steel the carrier material and/or the band can be guided around the electrode in a more simple manner and that the band fits better between the electrode and the metal sheet.

The band is guided around the electrode of the spot-welding gun, wherein a mirror-inverted imprint of the welding spot formed by the spot-welding process on the band when two or more metal sheets are welded, which imprint is detected and evaluated by the evaluation means and, thereafter, the band changes its position after a spot-welding process. Thus, it is advantageously achieved that the band protects the electrode, whereby the service life of the electrode is correspondingly increased. Likewise, it is advantageous that the band may be used for assuring quality, with the evaluation means detecting and evaluating the mirror-inverted imprint of the welding spot on the band.

Here, advantageously, a corresponding evaluation means provides for a substantially immediate and high-resolution detection of the welding spot on the band. Thus, evaluation of the welding-spot quality can be accelerated so that erroneous welding spots can be detected quickly and be appropriately reprocessed, in particular before further process steps are carried out.

By the measure of claim 20, it is advantageously achieved that the band protects the electrode, thus correspondingly increasing the service life of the electrode.

### BRIEF DESCRIPTION OF THE DRAWINGS

The present invention will be explained in more detail by way of the enclosed schematic drawings. Therein:

FIG. 1 is a diagrammatic view of a spot-welding device for the inventive method for monitoring quality of spot weldings in a simplified schematic representation;

FIG. 2 is a diagrammatic view of a section through a welding spot and an associated imprint on the electrode-protective band; and

FIGS. 3 to 7 show different embodiments of inventive bands with corresponding layers.

### DETAILED DESCRIPTION OF PREFERRED EMBODIMENTS

At first it is pointed out that same parts of the exemplary embodiment are designated by the same reference numbers.

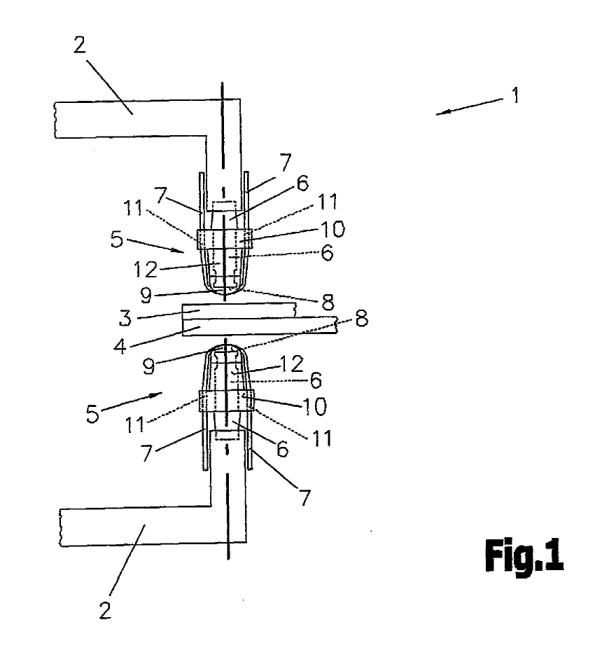

In FIG. 1, a spot-welding device 1 is shown in the form of a welding gun 2 for resistance welding of metal sheets 3, 4 or of components, which welding gun is preferably used for robot applications. Preferably, the spot-welding device 1 or the spot-welding gun has a spot-welding tool 5 and a winding unit (not illustrated) for winding and unwinding a band 7, or a foil, abutting on an electrode 6 in a transverse manner. The winding unit is arranged either directly on the welding gun 2 or outside thereof.

The band 7 may be guided around the electrode 6 in various ways, one exemplary embodiment being shortly discussed hereinafter. In the exemplary embodiment, it is not necessary to use a spot-welding gun 5, rather there only has to be the electrode 6, wherein the further components for guiding and winding and unwinding the band 7 are separate units and arranged accordingly. In the exemplary embodiment illustrated, a spacing element 9 is arranged around the electrode 6 in the range of an electrode cap 8 and/or a contact surface of the electrode 6 with the metal sheet 3, 4. For example, the spacing element 9 is movably fixed to the electrode 6 such that additional pressure can be applied on the metal sheets 3, 4 via said spacing element. Furthermore, the movable mounting of the spacing element 9 allows for the same to lift the band 7 off the electrode 6 after a welding process. When the welding gun 2 is being closed, the spacing element 9 is displaced relative to the electrode 6, whereby the band 7 abuts on the electrode 6.

In the exemplary embodiment illustrated, the spot-welding tool 5 has an annular structure, which is inserted into the welding gun 2, wherein the spacing element 9 consists of a metal ring with low electric conductivity, said metal ring being axially arranged on the cylindrical electrode 6 in a displacable manner. If no pressure is exerted, the spacing element 9 projects beyond the electrode 6. Moreover, a supporting element 10 is arranged on the electrode 6 which has guiding channels 11 for receiving the band 7. An adjustment means 12, in particular a spring element, is provided between the supporting element 10 and the spacing element 9, whereby the spacing element 9 can be displaced along the electrode 6 by exerting a certain pressure, wherein the adjustment means 12 is deformed and/or moved.

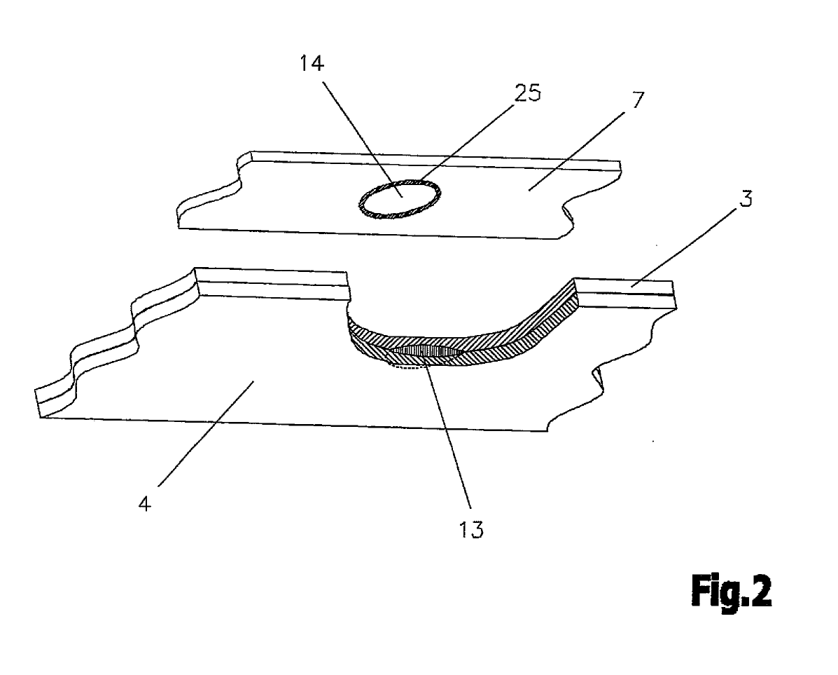

The metal sheets 3, 4 are pressed mechanically against each other during the spot-welding process via the electrodes 6 by the welding gun 2. During the spot-welding process the metal to be connected is melted quickly and for a short time by ohmic-resistance heating due to a current flow between the electrodes 6, wherein, subsequently, the molten region will quickly cool off and solidify due to the heat conductance. The metal sheets 3, 4 are interconnected via a welding spot 13 or a welding lens, as is schematically illustrated in FIG. 2.

The arising amount of heat and, thus, the volume of the molten material depend on the conductivity of the material of the metal sheets 3, 4, on the welding time, the welding current, more specifically on the current density through the welding spot 13 desired, and on the individual resistances of the welding circuit. The following parameters and conditions have to be taken into consideration when performing such a welding process, which can often be accounted for only by complex controlling, or which can not at all be monitored or influenced: the electric and thermal conductivity is material-specific but largely limited. The welding time is to be observed with relative little effort. By controlling the welding current, it can be kept at a constant level. However, deformed and, in particular worn, electrodes 6 may have the effect that the contact surface becomes too large and, thus, the current density too small. Moreover, previous welding spots 13 or deformations of the metal sheets 3, 4 may have the effect that the current does not flow through the welding spot 13 desired and does not contribute to the material melting. The resistance of the welding circuit, in particular the contact resistance mainly present, are subject to unpredictable and uncontrollable deviations caused, e.g. by contamination of the metal sheets 3, 4 or the electrode 6. Furthermore, bad welding spots 13 may be caused by inadequate positioning of the welding gun 2 or the metal sheets 3, 4 or by deformations of the metal sheets 3, 4 preventing the electrode 6 from contacting the metal sheet 3 or 4 or the metal sheets 3,4 from contacting each other, as would be required. Because of the reasons mentioned above it is urgently necessary to monitor the welding-spot quality and, in particular, to control the welding spot 13 after a welding process.

The method for monitoring quality of spot weldings is based on the principle to detect the maximum temperatures with their geometric expansion on the surfaces of the metal sheet(s), i.e. the welding spot 13. Here, the electrically well-conductive band 7 is between the electrode 6 and the metal sheet 3, 4, during the welding process. The band 7 changes its properties as a function of the highest temperature at the respective location such that a mirror-inverted, particularly proportional image or an imprint 14 (as schematically illustrated in FIG. 2) of the welding spot 13 created is formed on the band 7. This imprint 14 on the band 7 is detected and evaluated by an evaluation means (not illustrated). The imprint 14 allows for conclusions as to the size, shape and position of the welding spot 13. The evaluation means, i.e., e.g. a camera comprising an appropriate control unit, may be positioned directly on the welding gun 2 such that the band 7 passes by the evaluation means, allowing for the evaluation to be done. The evaluation means may also be arranged externally.

The mirror-inverted imprint 14 may be caused, e.g. by a thin coating on a carrier material 24 of the band 7. This coating is provided on each surface of the band 7 assigned to the metal sheets 3, 4, i.e. on the so-called metal-sheet side 15. In the region of the melting temperature of the material of the metal sheets 3, 4 to be welded, the coating changes the clearly visible or elsewise detectable properties or melts so that the mirror-inverted imprint 14 is formed. This imprint 14 is a measure for the size of the welding spot and can be evaluated with reasonable effort in an automized manner.

The imprint 14 is caused mainly by the tin layer 16 provided on the metal-sheet side 15 of the band 7. By the temperature prevailing during the spot-welding process, this tin layer 16 is molten and/or evaporated, thus forming the mirror-inverted imprint 14 of the welding spot 13 on the metal-sheet side 15 of the band 7.

When metal sheets 3, 4 made of aluminum are welded, a band 7 is preferably used which has a tin layer 16, and when galvanized metal sheets 3, 4, e.g. made of steel, are welded, a band 7 is preferably used which has a copper layer 21.

In order to allow for the imprint 14 to be detected and evaluated by the evaluation means, a certain contrast of the imprint 14 to the metal-sheet side 15 is necessary. The tin layer 16 causes a so-called annular ring 25 to form around the welding spot 13 and/or the imprint 14, by means of which the contrast is achieved. In known bands 7, the contrast is obtained only after a certain time, in particular after several hours. Accordingly, the imprint 14 can be detected only after the contrast required has formed.

According to the invention, appropriate contrast-enhancing layers are applied onto the band 7 so that the contrast will be obtained quickly and that the imprint 14 can be detected substantially directly after the spot-welding process by the evaluation means.

Thus, the evaluation means may be arranged in direct vicinity to the electrode 6, e.g. on the welding gun 2 and may detect, measure and evaluate the imprint 14. In particular, the quality of the welding spot 3 is determined based on the size, shape, surface, position and the penetration depth of the electrode 6 of the imprint 14. The evaluation means can determine the quality parameters substantially based on the diameter, the surface structure and/or the color of the imprint 14. To this end, it is required to clearly detect the diameter of the imprint 14. This is achieved by the inventive layers arranged on the band 7, in particular by the top layer or the two top layers, which cause the annular ring 25 to form around the imprint 14. Compared to the metal-sheet side 15 and the welding spot 13, this annular ring 25 is correspondingly differently colored, thus forming the contrast necessary. The annular ring 25 clearly separates the imprint 14 from the metal-sheet side 15 of the band 7. Thus, the evaluation means can exactly detect the diameter of the welding spot 13, and corresponding conclusions may be drawn as to the quality of the latter.

The position on the welding gun 2, to which the evaluation means is fastened, determines the time delay, with which the imprint 14 is detected. For example, the time delay is only twenty welding spots 13. Thus, it is also ensured that each welding spot 13 and its imprint 14 will be detected. This is also the case when the band 7 has to be changed.

Thus, the subsequent and complex detection of the imprints 14 on the band 7 known from the prior art is avoided. Until now, such type of detection was necessary since the contrast required for detection was obtained only after about two hours and, accordingly, the band 7 had to be changed in the meantime and/or the imprint 14 was already in the wound-up coil of the band 7.

Thanks to the substantially immediate evaluation of the imprints 14 erroneous welding spots 13 can be detected quickly and the corrections required can be done before the next processing steps will be performed on the welded metal sheets 3, 4.

According to the invention, the contrast necessary for a substantially immediate evaluation of the imprint 14 is realized by applying same and/or different layers onto the metal-sheet side 15 on the band 7. Here, the layers are applied on the band 7 preferably on either side, i.e. on the metal-sheet side 15 and the electrode side 17. In order to allow for the contrast-enhancing layers to be applied in a simple and cost-effective manner, an adhesive layer 18 is preferably applied onto the carrier material of the band 7, said adhesive layer serving as an adhesive promoter for the following layers. These measures significantly reduce the production costs and substantially minimize the wear of the electrode 6.

The band 7 and the layers applied are appropriately adapted to the material of the metal sheets 3, 4 and to the welding parameters necessary for the spot-welding process, in particular to the welding current.

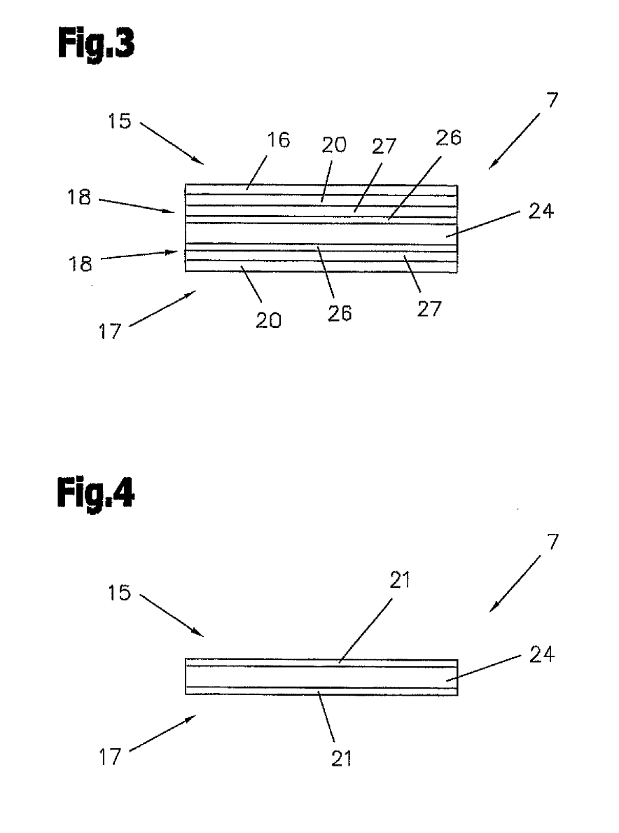

This can be learned from the following exemplary embodiments and the associated FIGS. 3 to 7. In FIG. 3, a band 7 for welding aluminum and/or aluminum alloys is shown, wherein the number of layers provided on the metal-sheet side 15 and on the electrode side 17 is different. Examples for the carrier material 24 of the band 7 are:

Steel of type ST 20, ST 40 and the like, i.e. soft types of steel. The thickness of the carrier material 24 is in the range of between 0.1 mm and 0.2 mm, in particular is 0.15 mm. The minimum tensile strength of the carrier material 24 of the band 7 is between 200 and 700 N/mm².

The adhesive layer 18 may be formed by two layers, e.g. a first adhesive layer 26 and a second adhesive layer 27, thus substantially facilitating production of the band 7.

On the metal-sheet side 15 of the band, there is a first adhesive layer 26 made of nickel, having a thickness of about 200 nm, in particular of less than 200 nm.

A second adhesive layer 27 made of nickel, which is applied, e.g. in a sulfamate bath, or made of a nickel alloy; thickness of in the range of between 0.1 μm and 0.5 μm, in particular of from 0.2 μm to 0.3 μm;

A layer 20 made of nickel-phosphorous; thickness of in the range of between 0.1 μm and 0.5 μm, in particular of from 0.2 μm to 0.3 μm;

A layer 16 made of tin; thickness of in the range of between 0.2 μm and 1.5 μm, in particular of from 0.5 μm to 0.7 μm.

Layers on the Electrode Side 17 of the Band:

A first adhesive layer 26 made of nickel; thickness of in the range of about 200 nm, in particular of less than 200 nm;

A second adhesive layer 27 made of nickel, which is applied in a sulfamate bath, or made of a nickel alloy; thickness of in the range of between 0.1 μm and 0.5 μm, in particular of from 0.2 μm to 0.3 μm;

A layer 20 made of nickel-phosphorous; thickness of in the range of between 1.0 μm and 0.5 μm, in particular of from 0.2 μm to 0.3 μm;

Welding Parameters:

Welding time: from 100 ms to 900 ms

Welding current: from 3 kA to 35 kA

Welding power: from 2 kN to 10 kN

FIG. 4 shows a band 7 for use when welding aluminum and/or aluminum alloys, in particular AlMgSi alloys, wherein the number of the layers of the metal-sheet side 15 and of the electrode side 17 is identical.

Carrier Material 24 of the Band 7:

Steel of type ST 20, ST 40 and the like, i.e. soft types of steel; the thickness is in the range of between 0.1 mm and 0.2 mm, in particular is 0.15 mm; the minimum tensile strength is in the range of between 200 and 700 N/mm²;

Layers Provided on the Metal-Sheet Side 15 and on the Electrode Side 17:

layer 21 made of copper; thickness of in the range of about 200 nm, in particular of less than 200 nm;

Welding Parameters:

Welding time: from 100 ms to 900 ms

Welding current: from 3 kA to 35 kA

Welding power: from 2 kN to 10 kN

According to the invention, a band 7 is used for evaluating the welding spot 13 and/or the imprint 14 during spot-welding of galvanized steel and/or steel alloys, said band being made of copper or a copper alloy (not illustrated).

The already-mentioned annular ring 25, which is usually blue or gray, around the yellowish imprint 14 of the welding spot 13 on the band 7 is achieved in that the tin molten by the spot-welding process is partly pushed outwards and sticks to the band 7, yet with no alloy formation.

The evaluation of quality of the welding spot 13 may also or additionally be done based on the color of the imprint 14. Since the color of the imprint 14 changes as a function of the surface temperature of the metal sheets 3, 4 welded, the color is a parameter representing the quality of the welding spot 13. The surface temperature depends on the welding current and on the heat introduction associated therewith into the metal sheets 3, 4 during the spot-welding process.

Welding Parameters:

Welding time: from 100 ms to 900 ms

Welding current: from 3 kA to 35 kA

Welding power: from 2 kN to 10 kN

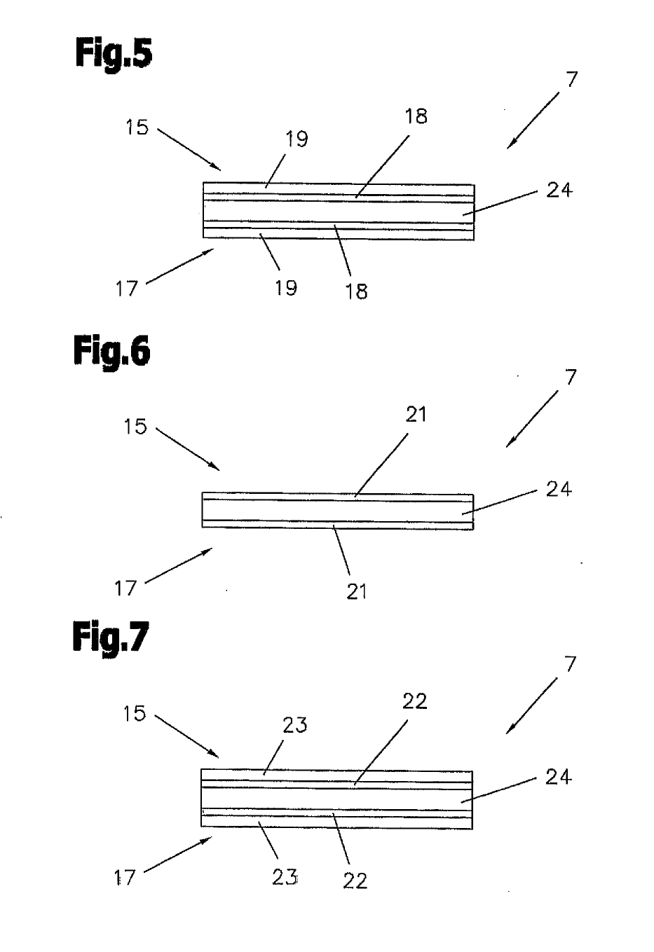

FIG. 5 shows a band 7 for use when welding aluminum and/or aluminum alloys, wherein the number of layers provided on the metal-sheet side 15 and on the electrode side 17, again, is identical.

Carrier Material 24 of the Band 7:

Steel of type ST 20, ST 40 and the like, i.e. soft types of steel; the thickness is in the range of between 0.1 mm and 0.2 mm, in particular is 0.15 mm; the minimum tensile strength is in the range of between 200 and 700 N/mm²;

Layers on the Metal-Sheet Side 15 and on the Electrode Side 17:

An adhesive layer 18 made of nickel; thickness of in the range of about 200 nm, in particular of less than 200 nm;

A layer 19 made of nickel, which is applied in a sulfamate bath, or made of a nickel alloy; thickness of in the region of between 0.1 μm and 0.5 μm, in particular of from 0.2 μm to 0.3 μm;

Welding Parameters:

Welding time: from 100 ms to 900 ms

Welding current: from 3 kA to 35 kA

Welding power: from 2 kN to 10 kN

FIG. 6 shows a band 7 for use when welding steel and/or steel alloys, wherein the number of layers provided on the metal-sheet side 15 and the electrode side 17, again, is identical.

Carrier Material 24 of the Band 7:

Steel of type ST 20, ST 40 and the like, i.e. soft types of steel; the thickness is in the range of between 0.1 mm and 0.2 mm, in particular is 0.15 mm; the minimum tensile strength is in the range of between 200 and 700 N/mm²;

Layers on the Metal-Sheet Side 15 and on the Electrode Side 17:

A layer 21 made of copper; thickness of in the range of between 0.1 μm and 0.6 μm, in particular of 0.2 μm or 0.5 μm;

Welding Parameters:

Welding time: from 100 ms to 900 ms

Welding current: from 3 kA to 35 kA

Welding power: from 2 kN to 10 kN

Of course, the layer 21 made of copper may also in this case be arranged on an adhesive layer 18 with a thickness of in the range of about 200 nm, said adhesive layer being arranged on the carrier material 24.

FIG. 7 shows a band 7 for use when welding steel and/or steel alloys, wherein the number of the layers provided on the metal-sheet side 15 and the electrode side 17 is identical.

Carrier Material 24 of the Band 7:

Copper with a thickness of in the range of between 0.1 and 0.3 mm, in particular of 0.2 mm.

Layers of the Metal-Sheet Side 15 and on the Electrode Side 17:

A layer 22 made of copper; thickness of in the range of between 0.5 μm and 1.5 μm, in particular of 1 μm;

A layer 23 made of nickel, which is applied in a sulfamate bath, or made of a nickel alloy; thickness of in the range of between 0.5 μm and 1.5 μm, in particular of 1 μm;

Welding Parameters:

Welding time: from 100 ms to 900 ms

Welding current: from 3 kA to 35 kA

Welding power: from 2 kN to 10 kN

Of course, the layer 22 made of copper may also in this case be arranged on an adhesive layer (not illustrated) with a thickness of in the range of about 200 nm, said adhesive layer being arranged on the carrier material 24.

To provide for a production of the band 7 which is as simple as possible and, therefore, cost-efficient, the layers on the metal-sheet side 15 and the electrode side 17 are identical. Moreover, the layers have corresponding properties so as to achieve the effect required on both sides of the band 7. Of course, the layers could be adapted to the respective requirements on the metal-sheet side 15 and the electrode side 17 in an even more efficient manner by applying different layers onto the metal-sheet side 15 and the electrode side 17.

A band 7 which is known from the prior art and has a tin coating may also be used, wherein the mirror-inverted imprint 14 on the band 7 is moistened to achieve a quicker contrast formation. This can be effected, e.g. by providing a device in front of the evaluation means which moistens the imprint, for example, with water, dispenses an ultrasonic fog or water steam, or which guides the band 7 with the metal-sheet side 15 across a humid felt or a humid roller. However, in contrast to the inventive bands 7 having a corresponding coating, this would involve significantly higher efforts.

What is claimed is:

1. A band (7) for protecting electrodes (6) of a spot-welding gun for welding metal sheets (3, 4) made of an aluminum alloy, in particular of an AlMgSi alloy, comprising a carrier material (24), wherein at least one electrically conductive layer (16) made of copper is provided on the side (15) facing the metal sheets (3, 4), wherein at least the copper layer (21) provided on the metal-sheet side (15) of the carrier material (24) has a thickness of in the range of 20 nm.

2. The band (7) according to claim 1, wherein a layer (21) is provided on the side (17) of the carrier material (24) facing the electrode (6), said layer (21) being made of copper and having a thickness of in the range of 200 nm.

3. A band (7) for protecting electrodes (6) of a spot-welding gun for welding metal sheets (3, 4) made of aluminum or an aluminum alloy, comprising a carrier material (24), wherein at least one electrically conductive layer (16) is provided on the side (15) facing the metal sheets (3, 4), and at least one layer (19) made of nickel and/or a nickel alloy is provided at least on the side (17) of the carrier material (24) facing the electrode (6), wherein the nickel layer (19) is arranged on an adhesive layer (18) made of nickel and provided on the carrier material (24), said nickel layer (19) having a thickness of from 0.1 μm to 0.5 μm.

4. The band (7) according to claim 3, wherein the adhesive layer (18) made of nickel has a thickness of in the range of about 200 nm.

5. A band (7) for protecting electrodes (6) of a spot-welding gun for welding metal sheets (3, 4) made of steel and/or steel alloys, comprising a carrier material (24), wherein at least one electrically conductive copper layer (16, 21) each is provided on the side (15) facing the metal sheets (3, 4) and on the side (17) of the carrier material (24) facing the electrode (6), wherein the copper layers (16, 21) have a thickness of between 0.1 μm and 0.6 μm.

6. A band (7) for protecting electrodes (6) of a spot-welding gun for welding metal sheets (3, 4) made of steel and/or steel alloys, comprising a carrier material (24), wherein at least one electrically conductive layer (16) is provided on the side (15) facing the metal sheets (3, 4), wherein at least two layers (22, 23) made of different materials are provided at least on the side (17) of the carrier material (24) facing the electrode (6), wherein one layer (22) is made of copper and one layer (23) is made of nickel and/or a nickel alloy, and wherein each layer (22, 23) has a thickness of from 0.5 μm to 1.5 μm.

7. The band (7) according to claim 6, wherein the copper layer (22) is provided on an adhesive layer with a thickness of in the range of 200 nm, said adhesive layer being arranged on the carrier material (24) and being made of copper.

8. The band (7) according to claim 6, wherein the carrier material (24) is made of copper and has a thickness of from 0.1 μm to 0.3 μm.

9. The band (7) according to claim 3, wherein the band (7) is guided around the electrode (6) of the spot-welding gun, and wherein the band (7) changes its position after a spot-welding process.
